(19) United States
(12) Patent Application Publication
(10) Pub. No.: US 2026/0204892 A1
(43) Pub. Date: Jul. 16, 2026

(54) POWER FEED CONTROL DEVICE

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Yuta TANINAKA, Yokkaichi-shi, Mie (JP); Kota ODA, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/133,989

(22) PCT Filed: Nov. 20, 2023
(86) PCT No.: PCT/JP2023/041558

§ 371 Date: May 29, 2025

(30) Foreign Application Priority Data
Nov. 30, 2022 (JP) 2022-191571

(51) Int. Cl. H02H 3/087; B60R 16/033; H02H 7/20; H02J 7/60; H02J 7/62

(52) U.S. Cl. CPC H02H 3/087; B60R 16/033; H02J 7/62; H02J 7/663; H02H 7/20

(57) ABSTRACT

Provided is a vehicle power feed control device that controls the supply of power to an in-vehicle device and includes a plurality of cutoff units that cut off the flow of a current exceeding a cutoff threshold to the in-vehicle device. The cutoff units include cutoff units whose cutoff thresholds are different from each other, and a group of cutoff units among the cutoff units is connected to a new in-vehicle device that is newly connected.

### CROSS-REFERENCE TO RELATED APPLICATIONS

This application is the U.S. national stage of PCT/JP2023/041558 filed on Nov. 20, 2023, which claims priority of Japanese Patent Application No. JP 2022-191571 filed on Nov. 30, 2022, the contents of which are incorporated herein.

### TECHNICAL FIELD

The present disclosure relates to a power feed control device provided in a vehicle.

### BACKGROUND

Conventionally, in a vehicle, a power feed control device is provided between a power source and in-vehicle devices, and distributes power from the power source to the in-vehicle devices.

JP 2019-38344A discloses a load control device that is provided between a power source and a load, and in this load control device, a line from the power source is branched into a plurality of lines, and the load control device is connected to the load via a plurality of branch lines as necessary.

If an overcurrent greater than or equal to a threshold flows through an in-vehicle device that includes an electrical device, a malfunction or damage may possibly occur, and therefore a cutoff unit for cutting off the flow of electricity is used when it is apparent that an overcurrent greater than or equal to a threshold will flow through the in-vehicle device. For example, the cutoff unit is provided on a power line connecting a power source to an in-vehicle device, and has a function of cutting off the power line when a current greater than or equal to a threshold flows.

For example, it is possible to envision a case in which a new in-vehicle device is additionally connected to the load control device, or an already connected in-vehicle device is replaced with a new in-vehicle device. However, there may be a case where the in-vehicle device threshold, which is the threshold determined for the additional or replacement new in-vehicle device, is higher than the cutoff unit threshold, which is the threshold of the cutoff unit that corresponds to the new in-vehicle device. There has been a problem that in such a case, the cutoff unit cannot perform the intended function described above.

However, J P 2019-38344A does not take such a problem into consideration and is unable to solve such a problem.

Therefore, an object of the present disclosure is to provide a power feed control device that can appropriately handle a case where the threshold of an additional or replacement new in-vehicle device is higher than the threshold of the cutoff unit of the power feed control device.

### SUMMARY

A power feed control device according to an aspect of the present disclosure is a vehicle power feed control device that controls a supply of power to an in-vehicle device, the power feed control device including: a plurality of cutoff units configured to cut off a flow of a current exceeding a cutoff threshold to the in-vehicle device, wherein the plurality of cutoff units include cutoff units whose cutoff thresholds are different from each other, and a group of cutoff units among the plurality of cutoff units is connected to a new in-vehicle device that is newly connected.

### Advantageous Effects

According to the present disclosure, it is possible to provide a power feed control device that can handle a case where the threshold of an additional or replacement new in-vehicle device is higher than the threshold of the cutoff unit of the power feed control device.

### BRIEF DESCRIPTION OF DRAWINGS

FIG. 1 is a functional block diagram showing a configuration of a relevant portion of a vehicle provided with a power feed control device according to a first embodiment.

FIG. 2 is a functional block diagram showing a configuration of a relevant portion of the power feed control device according to the first embodiment.

FIG. 3 is a functional block diagram showing a case where a new in-vehicle device is connected to an available power line of the power feed control device according to the first embodiment.

FIG. 4 is a functional block diagram showing a configuration of a relevant portion of a power feed control device according to a second embodiment.

### DETAILED DESCRIPTION OF PREFERRED EMBODIMENTS

First, embodiments of the present disclosure will be listed and described. Also, at least some of the embodiments described below may be combined in any desired manner.

In a first aspect, a power feed control device according to an aspect of the present disclosure is a vehicle power feed control device that controls a supply of power to an in-vehicle device, the power feed control device including: a plurality of cutoff units configured to cut off a flow of a current exceeding a cutoff threshold to the in-vehicle device, wherein the plurality of cutoff units include cutoff units whose cutoff thresholds are different from each other, and a group of cutoff units among the plurality of cutoff units is connected to a new in-vehicle device that is newly connected.

In this embodiment, a group of the cutoff units is connected to the new in-vehicle device, and therefore it is possible to handle the case where the threshold (in-vehicle device threshold) of the additional or replacement new in-vehicle device is greater than the cutoff threshold of the cutoff units of the power feed control device.

In a second aspect, in the power feed control device according to another aspect of the present disclosure, a sum of the cutoff thresholds of the cutoff units in the group of cutoff units is equivalent to an in-vehicle device threshold determined according to the new in-vehicle device.

In this embodiment, the sum of the cutoff thresholds of the cutoff units in the group of cutoff units connected to the new in-vehicle device is the same as the in-vehicle device threshold for the new in-vehicle device, and therefore a current exceeding the in-vehicle device threshold can be prevented from flowing to the new in-vehicle device.

In a third aspect, in the power feed control device according to another aspect of the present disclosure, the group of cutoff units includes cutoff units whose cutoff thresholds are different from each other.

In this embodiment, although the cutoff thresholds of the cutoff units in the group of the cutoff units connected to the new in-vehicle device are different from each other, the sum of the cutoff thresholds is equivalent to the in-vehicle device threshold for the new in-vehicle device, and therefore a current exceeding the in-vehicle device threshold can be prevented from flowing to the new in-vehicle device.

In a fourth aspect, in the power feed control device according to another aspect of the present disclosure, the cutoff units in the group of cutoff units have cutoff thresholds that are equivalent to each other.

In this embodiment, the cutoff thresholds of the cutoff units in the group of cutoff units connected to the new in-vehicle device are the same as each other, and the sum of the cutoff thresholds is equivalent to the in-vehicle device threshold for the new in-vehicle device, and therefore a current exceeding the in-vehicle device threshold can be prevented from flowing to the new in-vehicle device.

In a fifth aspect, in the power feed control device according to another aspect of the present disclosure, the cutoff units in the group of cutoff units are each connected in parallel to the new in-vehicle device.

In this embodiment, each of the cutoff units in the group of cutoff units is connected in parallel to the new in-vehicle device and cuts off a current exceeding the corresponding cutoff threshold from flowing to the new in-vehicle device. Therefore, a current exceeding the in-vehicle device threshold can be prevented from flowing to the new in-vehicle device.

In a sixth aspect, in the power feed control device according to another aspect of the present disclosure, the cutoff units in the group of cutoff units are each a semiconductor switch controlled to be open or closed, and the semiconductor switches are each switched open and closed based on a cutoff threshold set according to an in-vehicle device threshold determined according to the new in-vehicle device.

In this embodiment, a group of semiconductor switches are connected to the new in-vehicle device, the cutoff thresholds of the semiconductor switches are set according to the in-vehicle device threshold related to the new in-vehicle device, and opening and closing are controlled such that a current exceeding the cutoff thresholds does not flow to the new in-vehicle device. Therefore, a current exceeding the in-vehicle device threshold can be prevented from flowing to the new in-vehicle device.

A power feed control device according to embodiments of the present disclosure will be described below with reference to the drawings. However, the present disclosure is not limited to these examples, but rather is defined by the scope of the claims, and is intended to include all modifications within the meaning and scope equivalent to the claims.

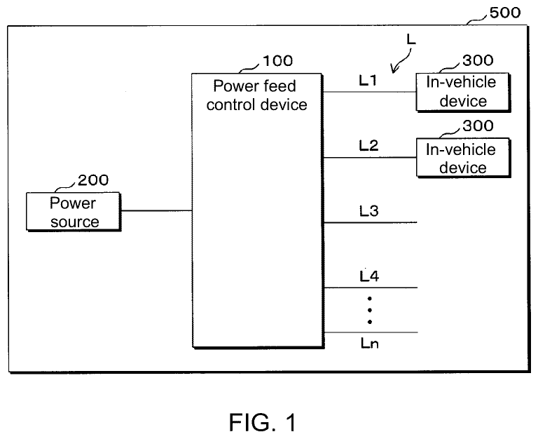

FIG. 1 is a functional block diagram showing the configuration of a relevant portion of a vehicle 500 provided with a power feed control device 100 according to a first embodiment. The vehicle 500 includes a plurality of in-vehicle devices 300, the power feed control device 100, and a power source 200.

The power source 200 is, for example, a battery, and the in-vehicle devices 300 are, for example, electrical devices such as a room lamp and a drive recorder. The power feed control device 100 is provided between the power source 200 and the in-vehicle devices 300, and controls the supply of power from the power source 200 to the in-vehicle devices 300.

For example, the power feed control device 100 according to the first embodiment includes a plurality of output terminals (not shown), and power lines L are respectively connected to the output terminals. The in-vehicle devices 300 are connected to the power feed control device 100 via the power lines L.

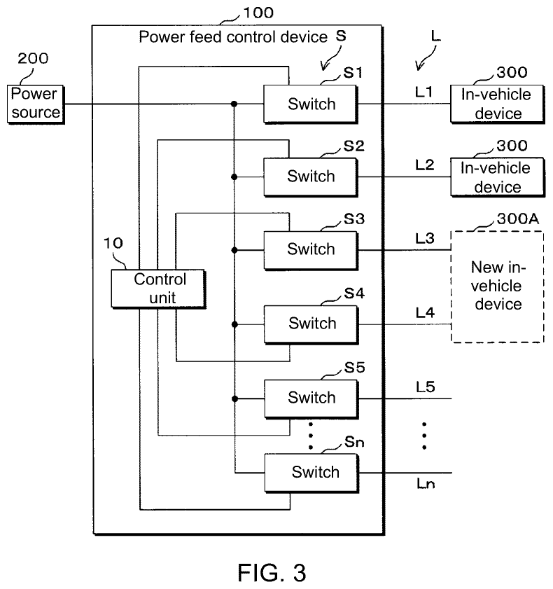

Power input from the power source 200 to the power feed control device 100 is distributed and supplied to the in-vehicle devices 300 via the power lines L. At this time, the power feed control device 100 controls the supply of power to the in-vehicle devices 300 and a new in-vehicle device 300A (FIG. 3) described later.

For convenience, the following description will be given by way of example of the case where the power feed control device 100 has n output terminals, that is, the case where n power lines L (power lines L1 to Ln) are connected to the power feed control device 100. Also, in the following description, the power lines L1 to Ln will also be simply referred to as the power lines L.

For example, in the power feed control device 100 according to the first embodiment, the in-vehicle devices 300 are connected to only some of the power lines L1 to Ln. In FIG. 1, the in-vehicle devices 300 are connected only to the power lines L1 and L2, and the in-vehicle devices 300 are not connected to the power lines L3 to Ln, and the power lines L3 to Ln are available power lines.

FIG. 1 illustrates the case where the in-vehicle devices 300 are connected only to the power lines L1 and L2, but the present disclosure is not limited to this. A new in-vehicle device 300 can be connected to an available power line L, or an already connected in-vehicle device 300 can be replaced with the new in-vehicle device 300. Hereinafter, among the in-vehicle devices 300, a newly added in-vehicle device 300 and a newly replaced in-vehicle device 300 will be collectively referred to as the new in-vehicle device 300A.

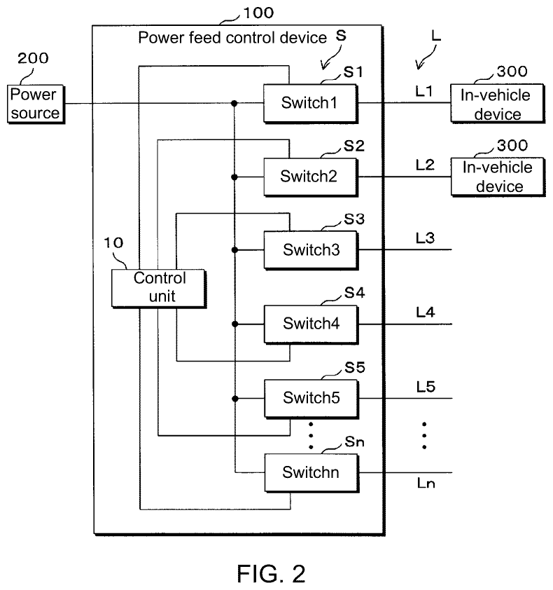

FIG. 2 is a functional block diagram showing the configuration of a relevant portion of the power feed control device 100 according to the first embodiment, and FIG. 3 is a functional block diagram showing the case where the new in-vehicle device 300A is connected to an available power line L of the power feed control device 100 according to the first embodiment.

The power feed control device 100 includes a plurality of switches S (cutoff units) and a control unit 10 that controls the supply of power to the in-vehicle devices 300 via the switches S. For example, the power feed control device 100 has n switches S (switches S1 to Sn).

The switches S are provided between the power source 200 and the in-vehicle devices 300 (new in-vehicle device 300A).

Specifically, one end of a power line connecting the power source 200 and the power feed control device 100 is connected to the power source 200, and the other end is branched into a plurality of lines respectively connected to the switches S1 to Sn. Also, the power lines L1 to Ln are respectively connected to the switches S1 to Sn, and the switches S1 to Sn are connected to the in-vehicle devices 300 (new in-vehicle device 300A) via the corresponding power lines L1 to Ln.

Each of the switches S is a semiconductor switch configured as, for example, an IPD (Intelligent Power Device). The switch S is configured as an IPD (Intelligent Power Device) that includes, for example, a FET (Field Effect Transistor) or an IGBT (Insulated Gate Bipolar Transistor). The switch S allows and cuts off the supply of power (current) through the power line L to the in-vehicle device 300 (new in-vehicle device 300A). Also, the switch S detects the current and notifies the control unit 10 of the current.

The control unit 10 is configured by a CPU (Central Processing Unit) or an MPU (Micro Processing Unit) or the like. The control unit 10 is connected to the switches S1 to Sn via an internal bus and a plurality of signal lines.

The control unit 10 performs PWM control by outputting (applying) a gate signal (PWM control signal) to the gate terminals of the switches S1 to Sn to open and close the switches S1 to Sn. Specifically, the switches S are each opened and closed in accordance with the PWM control signal input from the control unit 10, and a pulse voltage (power) is accordingly output to the in-vehicle device 300 (new in-vehicle device 300A).

In the power feed control device 100 illustrated in FIGS. 2 and 3, the switch S1 is connected to one in-vehicle device 300 via the power line L1, and the switch S2 is connected to another in-vehicle device 300 via the power line L2.

The switches S (including the switches S1 and S2) cut off overcurrent attempting to flow to the corresponding in-vehicle devices 300, and function as a so-called fuse. Specifically, a cutoff current value (cutoff threshold) of the switches S1 and S2 is set based on a threshold used to cut off an overcurrent (hereinafter referred to as the in-vehicle device threshold), which is determined according to the two in-vehicle devices 300 described above, and when a current exceeding the cutoff current value flows through the switches S1 and S2, the control unit 10 opens the switches S1 and S2. The cutoff current value is a threshold used when the switch S cuts off the flow of power to the in-vehicle device 300 (new in-vehicle device 300A), and corresponds to the fusing current value, cutoff current value, or the like of a general fuse.

For example, in the case where there is a risk of malfunction or damage when a current greater than 10 A flows through the in-vehicle devices 300, the in-vehicle device threshold for each of the in-vehicle devices 300 is 10 A, and therefore the cutoff current values of the switches S1 and S2 are each set to 10 A, and when a current greater than or equal to 10 A (cutoff current value) flows through the switch S1 or the switch S2, the control unit 10 opens the switch S1 or the switch S2, and an overcurrent exceeding the in-vehicle device threshold is prevented from flowing to the corresponding in-vehicle device 300.

Envision the case where the new in-vehicle device 300A is connected to the power feed control device 100, that is, the new in-vehicle device 300 is connected to an available power line L, or an already connected in-vehicle device 300 is replaced with the new in-vehicle device 300.

On the other hand, there may be also a case where the in-vehicle device threshold for the new in-vehicle device 300A exceeds the maximum current value at which the switch S connected to the new in-vehicle device 300A operates normally, that is, the maximum current value that is allowable (hereinafter, the maximum allowable current value). For example, there may be a case where the in-vehicle device threshold for the new in-vehicle device 300A is 15 A, whereas the maximum allowable current value of the switch S connected to the new in-vehicle device 300A is 10 A. In such a case, the switch S will not operate correctly at a current greater than or equal to 10 A and will not be able to function properly as described above.

The power feed control device 100 according to the first embodiment can handle such a problem. This will be described below. In the following, as shown in FIG. 3, the case where the new in-vehicle device 300A is connected to an available power line L will be described as an example, and it is assumed that the maximum allowable current value of each of the switches S1 to Sn is 10 A.

As described above, in the case where the in-vehicle device threshold for the new in-vehicle device 300A is 15 A and the maximum allowable current value of each of the switches S that can be connected to the new in-vehicle device 300A is 10 A, in the power feed control device 100 of the first embodiment, a plurality of switches S are connected to the new in-vehicle device 300A.

For example, the switches S3 and S4 (a group of switches) are connected to the new in-vehicle device 300A (see FIG. 3). The switches S3 and S4 are each connected in parallel to the new in-vehicle device 300A, and the cutoff current values of the switches S3 and S4 are each set to 7.5 A. In other words, the cutoff current values of the switches S3 and S4 are set such that the sum of the cutoff current values of the switches S3 and S4 is the same as the in-vehicle device threshold of the new in-vehicle device 300A. As a result, the current flowing to the new in-vehicle device 300A is divided between the switches S3 and S4, and the divided flows of current do not exceed the maximum allowable current value of the switches S3 and S4.

Thereafter, the control unit 10 monitors the switches S3 and S4, and when a current exceeding 7.5 A (the cutoff current value) flows through the switch S3 or the switch S4, the control unit 10 performs control to open the switch S3 and the switch S4 sequentially or simultaneously.

This prevents an overcurrent exceeding 15 A (the in-vehicle device threshold) from flowing to the new in-vehicle device 300A, thereby achieving an effect similar to that when a switch S with a cutoff current value of 15 A is connected to the new in-vehicle device 300A. Therefore, the power feed control device 100 according to the first embodiment can handle the case where the in-vehicle device threshold for the new in-vehicle device 300A is greater than the maximum allowable current value of each of the switches S. Therefore, even if an unexpected new in-vehicle device 300A is connected to the power feed control device 100, power can be supplied appropriately regardless of the new in-vehicle device 300A.

### Second Embodiment

In the first embodiment, the case where the cutoff units (switches S) are semiconductor switches has been described as an example, but the present disclosure is not limited to this. In the second embodiment, a general fuse is used as the cutoff unit. This will be described in detail below.

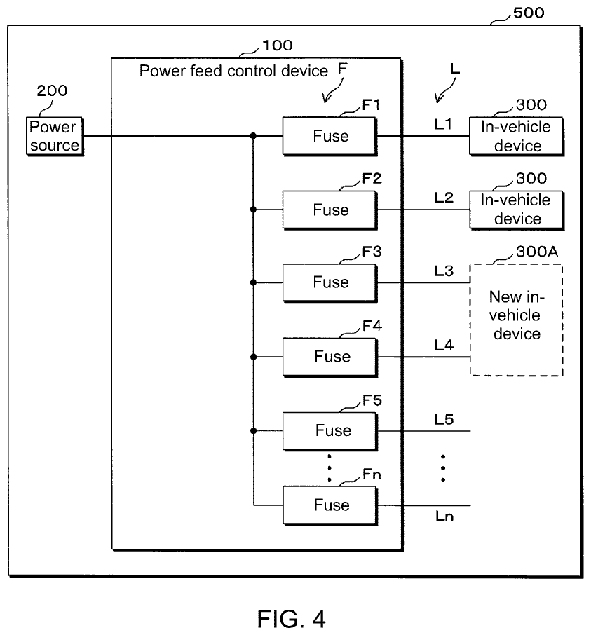

FIG. 4 is a functional block diagram showing the configuration of a relevant portion of the power feed control device 100 according to the second embodiment. FIG. 4 shows the case where the new in-vehicle device 300A is connected to an available power line L of the power feed control device 100 according to the second embodiment, and for convenience, the new in-vehicle device 300A is indicated by dashed lines.

As in the first embodiment, the vehicle 500 includes a plurality of in-vehicle devices 300, the power feed control device 100, and the power source 200, and the power feed control device 100 is provided between the power source 200 and the in-vehicle devices 300 (new in-vehicle device 300A) and controls the supply of power from the power source 200 to the in-vehicle devices 300 (new in-vehicle device 300A).

The in-vehicle devices 300 (new in-vehicle device 300A) are connected to the power feed control device 100 via the power lines L, and power input from the power source 200 to the power feed control device 100 is distributed and supplied to the in-vehicle devices 300 (new in-vehicle device 300A) via the power lines L. At this time, the power feed control device 100 controls the supply of power to each of the in-vehicle devices 300 (new in-vehicle device 300A).

FIG. 4 illustrates a case where the in-vehicle devices 300 are connected only to the power lines L1 and L2, and the new in-vehicle device 300A is connected to the power lines L3 and L4 among the available power lines L3 to Ln.

The power feed control device 100 of the second embodiment includes general vehicle fuses F instead of the switches S. For example, the power feed control device 100 has n fuses F (fuses F1 to Fn).

The fuses F are provided between the power source 200 and the in-vehicle devices 300 (new in-vehicle device 300A). One end of a power line connecting the power source 200 and the power feed control device 100 is connected to the power source 200, and the other end is branched into a plurality of lines respectively connected to the fuses F1 to Fn. Also, the power lines L1 to Ln are respectively connected to the fuses F1 to Fn, and the fuses F1 to Fn are connected to the in-vehicle devices 300 (new in-vehicle device 300A) via the corresponding power lines L1 to Ln.

Each of the fuses F is a general vehicle fuse, such as a blade type fuse, a low-profile fuse, or a tube type fuse. In other words, according to the inherent fusing characteristics, the fuse F is blown when a predetermined fusing current flows.

For example, in the example of FIG. 4, if a current greater than or equal to the fusing current value (cutoff threshold) flows through the fuse F1 or the fuse F2, the fuse F1 or the fuse F2 blows, and an overcurrent exceeding the in-vehicle device threshold is prevented from flowing through the corresponding in-vehicle device 300.

Envision the case where the new in-vehicle device 300A is connected to the power feed control device 100, that is, the new in-vehicle device 300A is connected to an available power line L, or an already connected in-vehicle device 300 is replaced with the new in-vehicle device 300A.

On the other hand, there may be also a case where the in-vehicle device threshold for the new in-vehicle device 300A exceeds the fusing current value of the fuse F connected to the new in-vehicle device 300A. For example, there may be the case where the in-vehicle device threshold for the new in-vehicle device 300A is 15 A, whereas the fusing current value of the fuse F connected to the new in-vehicle device 300A is 7.5 A. In such a case, the fuse F will not be able to function properly as a fuse.

The power feed control device 100 according to the second embodiment can handle such a problem. This will be described below. For convenience, the following description will be given by way of example of the case where the new in-vehicle device 300A is connected to an available power line L.

As described above, in the case where the fusing current value of each of the fuses F that can be connected to the new in-vehicle device 300A is smaller than the in-vehicle device threshold of the new in-vehicle device 300A, in the power feed control device 100, a plurality of fuses F are connected to the new in-vehicle device 300A. More specifically, based on the fusing current value of each of the fuses F, a combination of fuses F is connected to the new in-vehicle device 300A in accordance with the in-vehicle device threshold determined according to the new in-vehicle device 300A.

For example, in the case where the in-vehicle device threshold determined according to the new in-vehicle device 300A is 15 A, the fuses F3 and F4 each having a fusing current value of 7.5 A are connected to the new in-vehicle device 300A (see FIG. 4). The fuses F3 and F4 are connected in parallel to the new in-vehicle device 300A.

In other words, the sum of the fusing current values of the fuses F3 and F4 is the same as the in-vehicle device threshold for the new in-vehicle device 300A. As a result, the current flowing to the new in-vehicle device 300A is divided between the fuses F3 and F4, and the divided flows of current do not exceed the fusing current values of the fuses F3 and F4.

As a result, an overcurrent exceeding 15 A (in-vehicle device threshold) is prevented from flowing to the new in-vehicle device 300A, thereby achieving an effect similar to that when a fuse F with a fusing current value of 15 A is connected to the new in-vehicle device 300A. Therefore, the power feed control device 100 according to the second embodiment can handle the case where the in-vehicle device threshold for the new in-vehicle device 300A is higher than the fusing current value of each of the fuses F. Accordingly, even if an unexpected new in-vehicle device 300A is connected to the power feed control device 100, power can be supplied appropriately regardless of the new in-vehicle device 300A.

In the first embodiment, an example is described in which a combination of two switches S (the switches S3 and S4) is connected to the new in-vehicle device 300A, and in the second embodiment, an example is described in which a combination of two fuses F (the fuses F3 and F4) is connected to the new in-vehicle device 300A, but the present disclosure is not limited to this. For example, a combination of three or more switches S or fuses F may be connected to the new in-vehicle device 300A.

Also, in the first embodiment, an example is described in which the cutoff current values of the switches S in the combination of switches S connected to the new in-vehicle device 300A are the same (are all 7.5 A), and in the second embodiment, an example is described in which the fusing current values of the fuses F in the combination of fuses F connected to the new in-vehicle device 300A are the same (are all 7.5 A), but the present disclosure is not limited to this. The cutoff current values of the switches S in the combination may be cutoff current values that are different from each other (e.g., 10 A and 5 A), and the fusing current values of the fuses F in the combination may be fusing current values that are different from each other (e.g., 10 A and 5 A).

Furthermore, in the first embodiment, an example is described in which the power feed control device 100 has only the switches S, and in the second embodiment, an example is described in which the power feed control device 100 has only the fuses F, but the present disclosure is not limited to this. The power feed control device 100 may be configured to include both the switches S and the fuses F.

The embodiments disclosed herein should be considered in all respects as illustrative and not restrictive. The scope of the present disclosure is defined by the claims, not by the above meaning, and is intended to include all modifications within the meaning and scope equivalent to the claims.

The matter described in the respective embodiments can be combined with each other. Furthermore, the independent and dependent claims set forth in the claims can be combined with each other in any and all combinations, regardless of the form of reference. Furthermore, the claims are in a format in which a claim references two or more other claims (multiple dependent claim format), but are not limited to this format. It is also possible to use a format for describing multiple dependent claims (multi-multi claims) that cite at least one multiple dependent claim.

1. A vehicle power feed control device that controls a supply of power to an in-vehicle device, the power feed control device comprising:
a plurality of cutoff units configured to cut off a flow of a current exceeding a cutoff threshold to the in-vehicle device,
wherein the plurality of cutoff units include cutoff units whose cutoff thresholds are different from each other,
a group of cutoff units among the plurality of cutoff units is connected to a new in-vehicle device that is newly connected, and
a sum of the cutoff thresholds of the cutoff units in the group of cutoff units is equivalent to an in-vehicle device threshold determined according to the new in-vehicle device.

2. (canceled)

3. The power feed control device according to claim 1, wherein the group of cutoff units includes cutoff units whose cutoff thresholds are different from each other.

4. The power feed control device according to claim 1, wherein the cutoff units in the group of cutoff units have cutoff thresholds that are equivalent to each other.

5. The power feed control device according to claim 1, wherein the cutoff units in the group of cutoff units are each connected in parallel to the new in-vehicle device.

6. The power feed control device according to claim 1,
wherein the cutoff units in the group of cutoff units are each a semiconductor switch controlled to be open or closed, and
the semiconductor switches are each switched open and closed based on a cutoff threshold set according to an in-vehicle device threshold determined according to the new in-vehicle device.

7. The power feed control device according to claim 3,
wherein the cutoff units in the group of cutoff units are each a semiconductor switch controlled to be open or closed, and
the semiconductor switches are each switched open and closed based on a cutoff threshold set according to an in-vehicle device threshold determined according to the new in-vehicle device.

8. The power feed control device according to claim 4,
wherein the cutoff units in the group of cutoff units are each a semiconductor switch controlled to be open or closed, and
the semiconductor switches are each switched open and closed based on a cutoff threshold set according to an in-vehicle device threshold determined according to the new in-vehicle device.

9. The power feed control device according to claim 5,
wherein the cutoff units in the group of cutoff units are each a semiconductor switch controlled to be open or closed, and
the semiconductor switches are each switched open and closed based on a cutoff threshold set according to an in-vehicle device threshold determined according to the new in-vehicle device.
